(19) United States
(12) Patent Application Publication
(10) Pub. No.: US 2026/0045867 A1
(43) Pub. Date: Feb. 12, 2026

(54) INTEGRATED BATTERY HEATER AND CONDITIONER

(71) Applicant: VERTIV CORPORATION, Westerville, OH (US)

(72) Inventors: Douglas Keith Maly, Stubicke Toplice (HR); Bosko Mrkovic, Konjscina (HR); Steven V. Ricca, Arlington, OH (US)

(21) Appl. No.: 19/276,816

(22) Filed: Jul. 22, 2025

Related U.S. Application Data
(60) Provisional application No. 63/680,284, filed on Aug. 7, 2024.

(51) Int. Cl. H02M 1/12; H02M 3/155

(52) U.S. Cl. CPC H02M 1/12; H02M 3/155

(57) ABSTRACT

A battery control circuit may include a switched-mode power converter including one or more switches to control current to or from a battery. The battery control circuit may further include a controller to control operational states of the one or more switches in one of two or more operational modes: a harmonic-suppressed mode associated with first control signals to the one or more switches in which harmonic currents from the switched-mode power converter are at least one of suppressed from reaching the battery or eliminated; and a harmonic-allowed mode associated with second control signals to the one or more switches in which at least some harmonic currents from the switched-mode power converter reach the battery.

### CROSS-REFERENCE TO RELATED APPLICATION

The present application claims the benefit under 35 U.S.C. § 119(e) of U.S. Provisional Application Ser. No. 63/680,284, filed Aug. 7, 2024, entitled INTEGRATED BATTERY HEATER AND CONDITIONER, naming Douglas Keith Maly, Bosko Mrkovic, and Steve Ricca as inventors, which is incorporated herein by reference in the entirety.

### TECHNICAL FIELD

The present disclosure relates generally to battery heating and, more particularly, to battery heating using harmonic currents.

### BACKGROUND

A battery may typically function properly within a specified operational temperature range but may malfunction or cease to function outside of this operational temperature range. For example, performance of a battery operating at a lower end of an operational temperature range may improve if the battery is preheated. In particular, characteristics such as capacity, runtime, internal resistance, charge times, or reliability may improve.

Typical solutions for maintaining battery temperature and/or pre-heating a battery include a heater provided as a separate device. However, such an external heater generally increases cost, size, and weight of a battery package.

There is therefore a need to develop systems and methods for battery heating that cure the above deficiencies.

### SUMMARY

In embodiments, the techniques described herein relate to a battery control circuit including a switched-mode power converter including one or more switches to control current to or from a battery; and a controller to control operational states of the one or more switches, where the controller is configured to operate the switched-mode power converter in one of two or more operational modes, where the two or more operational modes include a harmonic-suppressed mode associated with first control signals to the one or more switches in which harmonic currents from the switched-mode power converter are at least one of suppressed from reaching the battery or eliminated; and a harmonic-allowed mode associated with second control signals to the one or more switches in which the harmonic currents from the switched-mode power converter reach the battery.

In embodiments, the techniques described herein relate to a battery control circuit, where the controller is configured to operate in the harmonic-allowed mode when a temperature of the battery is below an operational temperature range of the battery, where the controller is configured to operate in the harmonic-suppressed mode when the temperature is within the operational temperature range.

In embodiments, the techniques described herein relate to a battery control circuit, where the harmonic currents reaching the battery in the harmonic-allowed mode are configured to condition the battery.

In embodiments, the techniques described herein relate to a battery control circuit, where the harmonic currents reaching the battery in the harmonic-allowed mode are configured to condition the battery by at least one of dissolving inert compounds, loosening adhered active material, or freeing trapped electrolytes.

In embodiments, the techniques described herein relate to a battery control circuit, where the battery is a lead-acid battery, where the harmonic currents reaching the battery in the harmonic-allowed mode are configured to condition the battery by freeing sulfate crystals from plates in the battery.

In embodiments, the techniques described herein relate to a battery control circuit, where the battery is a lithium-ion battery, where the harmonic currents reaching the battery in the harmonic-allowed mode are configured to condition the battery by conditioning lithium metal plating in the battery.

In embodiments, the techniques described herein relate to a battery control circuit, where the harmonic currents reaching the battery in the harmonic-allowed mode are configured to extend an operational lifetime of the battery.

In embodiments, the techniques described herein relate to a battery control circuit, where the harmonic currents reaching the battery in the harmonic-allowed mode are configured to regain lost capacity of the battery.

In embodiments, the techniques described herein relate to a battery control circuit, where the switched-mode power converter includes a filter, where operation of the filter is controlled by at least one of the one or more switches, where the filter is operational in the harmonic-suppressed mode to provide that the harmonic currents from the switched-mode power converter are at least one of suppressed from reaching the battery or eliminated, where the filter is bypassed in the harmonic-allowed mode to provide that the harmonic currents from the switched-mode power converter reach the battery.

In embodiments, the techniques described herein relate to a battery control circuit, where the switched-mode power converter includes a filter, where operation of the filter is controlled by at least one of the one or more switches, where the filter is operational in the harmonic-suppressed mode to provide that the harmonic currents from the switched-mode power converter are at least one of suppressed from reaching the battery or eliminated, where the filter is tuned in the harmonic-allowed mode to provide that the harmonic currents from the switched-mode power converter that reach the battery have at least one of tailored frequencies or amplitudes.

In embodiments, the techniques described herein relate to a battery control circuit, where the filter includes at least one of an inductor in series with the battery or a capacitor in parallel with the battery.

In embodiments, the techniques described herein relate to a battery control circuit, where the first control signals include first PWM signals (pulse width modulation signals), where the second control signals include second PWM signals.

In embodiments, the techniques described herein relate to a battery control circuit, where the first PWM signals and the second PWM signals differ by at least one of frequency or duty cycle.

In embodiments, the techniques described herein relate to a battery control circuit, where the switched-mode power converter includes at least one of a DC/DC (direct current to direct current) power converter, an AC/DC (alternating current to direct current) power converter, or an AC/AC power converter.

In embodiments, the techniques described herein relate to a battery control circuit including a controller to control operational states of one or more switches of a switched-mode power converter for controlling current to or from a battery, where the controller is configured to operate the switched-mode power converter in one of two or more operational modes, where the two or more operational modes include a harmonic-suppressed mode associated with first control signals to the one or more switches in which harmonic currents from the switched-mode power converter are at least one of suppressed from reaching the battery or eliminated; and a harmonic-allowed mode associated with second control signals to the one or more switches in which the harmonic currents from the switched-mode power converter reach the battery.

In embodiments, the techniques described herein relate to a battery control circuit, where the controller is configured to operate in the harmonic-allowed mode when a temperature of the battery is below an operational temperature range of the battery, where the controller is configured to operate in the harmonic-suppressed mode when the temperature is within the operational temperature range.

In embodiments, the techniques described herein relate to a battery control circuit, where the harmonic currents reaching the battery in the harmonic-allowed mode are configured to at least one of condition the battery, extend an operational lifetime of the battery, or regain lost capacity of the battery.

In embodiments, the techniques described herein relate to a battery control method including monitoring one or more characteristics of a battery; applying first control signals to one or more switches of a switched-mode power converter to operate the switched-mode power converter in a harmonic-suppressed mode when the battery is in a first state, where harmonic currents from the switched-mode power converter are suppressed from reaching the battery; and applying second control signals to the one or more switches to operate the switched-mode power converter in a harmonic-allowed mode when the battery is in a second state, where at least some of the harmonic currents from the switched-mode power converter are allowed to reach the battery.

In embodiments, the techniques described herein relate to a battery control method, where the second state is applied when a temperature of the battery below an operational temperature range of the battery, where the first state is applied when the temperature is within the operational temperature range.

In embodiments, the techniques described herein relate to a battery control method, where the harmonic currents reaching the battery in the harmonic-allowed mode are configured to at least one of condition the battery, extend an operational lifetime of the battery, or regain lost capacity of the battery.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a simplified schematic of a power system, in accordance with one or more embodiments of the present disclosure.

FIG. 2A illustrates a simplified schematic diagram of a switched-mode power converter 104 suitable for operation in a UPS, in accordance with one or more embodiments of the present disclosure.

FIG. 2B illustrates a simplified schematic diagram of the switched-mode power converter 104 of FIG. 2A in which the filter 208 has been bypassed, in accordance with one or more embodiments of the present disclosure.

FIG. 3 illustrates a flow diagram illustrating steps performed in a method for applying harmonic currents to a battery, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing controllable harmonic currents to a battery.

Typical battery control circuitry governing charging and/or discharging of a battery includes one or more switched-mode converters that utilize switches (e.g., transistors, or any other suitable components) to control current flow. Such switched-mode converters may often produce alternating current (AC) harmonic currents, referred to herein simply as harmonic currents. In many cases, these harmonic currents are spectrum rich and include many frequencies or frequency ranges. Harmonic currents, particularly spectrum-rich harmonic currents, are generally considered to be undesirable as they may undesirably heat and/or degrade an attached battery. For this reason, typical battery control circuitry includes various filters to eliminate or reduce harmonic currents. Further, typical battery conditioning circuitry may include dedicated circuitry to generate high fidelity sinusoidal currents to be applied to a battery.

However, it is contemplated herein that the controlled application of harmonic currents to a battery may be advantageously utilized for various applications. In some embodiments, harmonic currents may be intentionally provided to a battery to controllably heat the battery, either as a pre-heating step or to maintain a battery temperature within a desired operational temperature range (e.g., when environmental conditions are colder than the desired operational temperature range). In this way, the controlled use of harmonic currents may eliminate or reduce the need for an external heater, which may provide substantial benefits for cost, size, and weight. In some embodiments, harmonic currents may be intentionally provided to a battery to condition the battery by dissolving inert compounds, loosening adhered active material, freeing trapped electrolytes, or providing any other conditioning step. In this way, the controlled use of harmonic currents may facilitate high performance and long battery lifetimes.

It is further contemplated herein that the systems and methods disclosed herein may have benefits over existing battery heating or conditioning techniques. For example, systems and methods disclosed herein may utilize harmonic currents from existing hardware (e.g., battery control circuitry that drive switches) for battery heating and/or conditioning, which may be simpler and/or more cost-effective than systems that utilize dedicated circuitry providing tailored signals (e.g., high fidelity sinusoidal signals at specific frequencies).

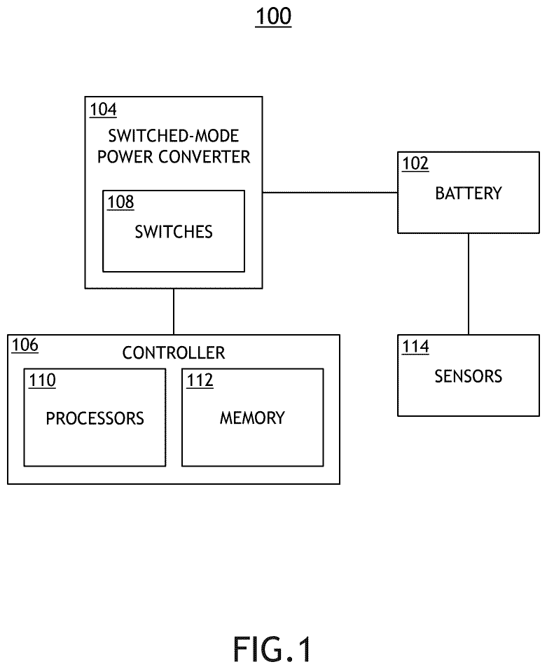

Referring now to FIGS. 1-3, systems and methods providing controlled application of harmonic currents to a battery are described, in accordance with one or more embodiments of the present disclosure.

FIG. 1 illustrates a simplified schematic of a power system, in accordance with one or more embodiments of the present disclosure.

In some embodiments, a power system 100 includes a battery 102, a switched-mode power converter 104, and a controller 106 to control operational states of one or more switches 108 within the switched-mode power converter 104.

The battery 102 may include any type of battery 102 with any type of chemistry known in the art including, but not limited to, lithium ion, nickel cadmium, or lead-acid. Further, the battery 102 may include multiple battery units connected in series or parallel to achieve any desired operating voltage and/or current requirements.

The switched-mode power converter 104 may include any type of power converter known in the art. For example, the switched-mode power converter 104 may include a DC/DC (direct current to direct current) converter to interface between a battery voltage (e.g., an operational voltage of the battery 102) and another DC voltage. As another example, the switched-mode power converter 104 may include an AC/DC converter to convert an input AC signal to a DC voltage (e.g., operating as a rectifier) or to convert a DC voltage to an AC signal (e.g., operating as an inverter). As another example, the switched-mode power converter 104 may include an AC/AC converter. In some cases, an AC/AC converter may be formed as an AC/DC/AC converter (e.g., an AC/AC converter with a DC link), which may include an AC/DC component and a DC/AC component. Further, any of the components, or blocks, of the switched-mode power converter 104 (e.g., AC/DC components, DC/AC components, or the like) may be controlled independently and in some cases may be bi-directional.

Further, the switches 108 may include any type of switches known in the art. For example, the switches 108 may include transistors such as, but not limited to, insulated-gate bipolar transistors (IGBTs), field-effect transistors (FETs), metal-oxide-semiconductor FETs (MOSFETs), or bipolar junction transistors (BJTs).

The controller 106 may include one or more processors 110 configured to execute program instructions stored on memory 112 (e.g., a memory device). In this way, the controller 106 may be configured to perform one or more functions of the power system 100 such as, but not limited to, sending control signals to one or more switches 108 within the switched-mode power converter 104.

The processors 110 may include any type of processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the processors 110 may include any device configured to execute algorithms and/or instructions (e.g., program instructions stored in memory 112). In one embodiment, the processors 110 may be embodied as a desktop computer, mainframe computer system, workstation, image computer, parallel processor, networked computer, or any other computer system configured to execute a program configured to operate or operate in conjunction with the system, as described throughout the present disclosure. Moreover, different subsystems of the system may include a processor or logic elements suitable for carrying out at least a portion of the steps described in the present disclosure. Therefore, the above description should not be interpreted as a limitation on the embodiments of the present disclosure but merely as an illustration.

The memory 112 may include a tangible, computer-readable storage medium that provides storage functionality to store various data and/or program code associated with operation of the controller 106 and/or other adapter components, such as software programs and/or code segments, or other data to instruct the controller 106, processors 110, and/or other elements to perform (e.g., cause the processors 110 to perform) the functionality described herein. Thus, the memory 112 can store data, such as a program of instructions for operating the power system 100. It should be noted that while a single memory is described, a wide variety of types and combinations of memory (e.g., tangible, non-transitory memory) can be employed. The memory 112 may be integral with the controller, can comprise stand-alone memory, or can be a combination of both. Some examples of the memory can include removable and non-removable memory components, such as random-access memory (RAM), read-only memory (ROM), flash memory (e.g., a secure digital (SD) memory card, a mini-SD memory card, and/or a micro-SD memory card), solid-state drive (SSD) memory, magnetic memory, optical memory, universal serial bus (USB) memory devices, hard disk memory, external memory, and so forth.

In some embodiments, the controller 106 generates control signals to control operational states of the switches 108. In this way, the control signals may dictate whether any of the switches 108 are in a conductive state (e.g., a closed state) or a non-conductive state (e.g., an open state). For example, power conversion (e.g., DC/DC conversion, AC/DC conversion, or the like) may be achieved by repeatedly switching the operational states of different switches 108 or groups thereof to control current flow throughout the switched-mode power converter 104.

In some cases, controller 106 is a pulse-width modulation (PWM) controller such that the control signals are PWM signals. In this configuration, parameters such as a switching frequency and/or a pulse width of the control signals may be adjusted to control current flow through the switched-mode power converter 104.

The power system 100 may thus provide any type of AC or DC power control with the battery 102. In some embodiments, the power system 100 is or is integrated within an uninterruptible power supply (UPS). In this configuration, the power system 100 may selectively power a load based on any combination of input power (e.g., from AC or DC input sources) or the battery 102. A power system 100 operating as a UPS may further charge the battery 102 from the input power.

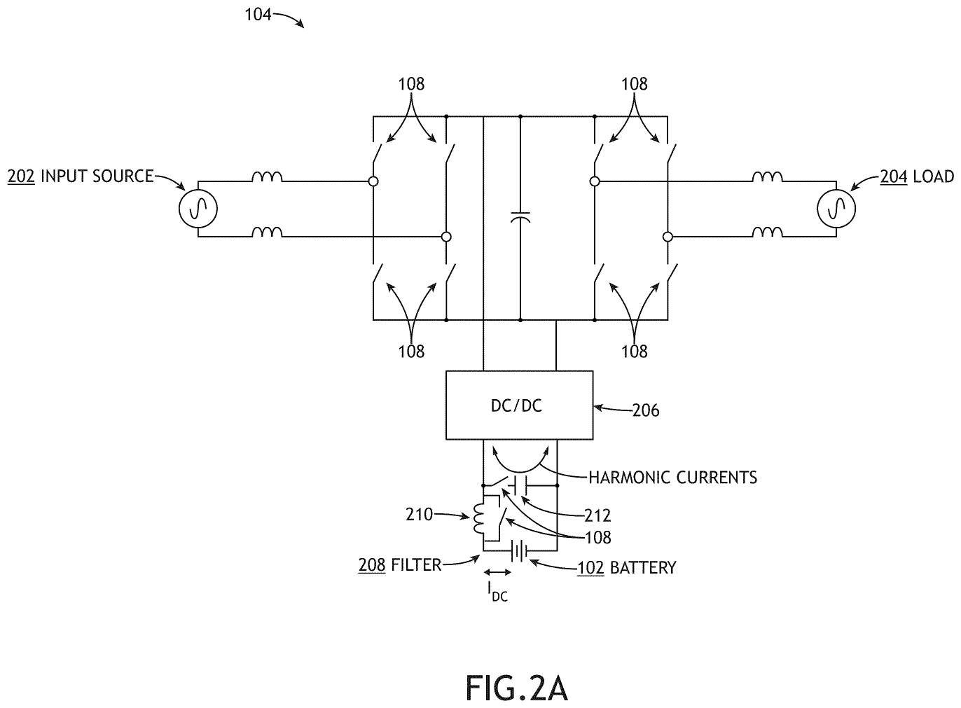

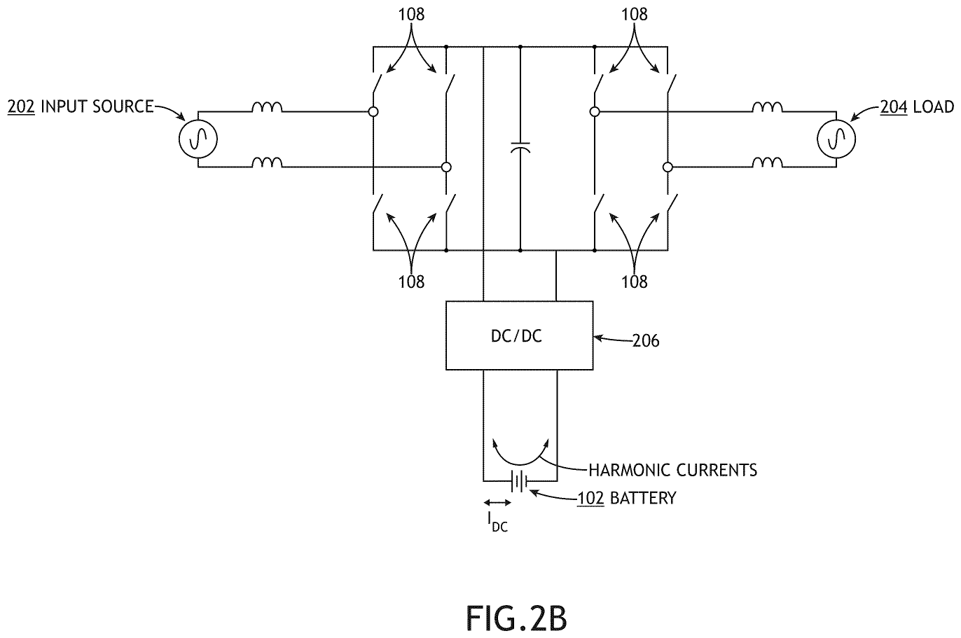

As an illustration, FIG. 2A illustrates a simplified schematic diagram of a switched-mode power converter 104 suitable for operation in a UPS, in accordance with one or more embodiments of the present disclosure. In FIG. 2A, the switched-mode power converter 104 receives an AC signal from an AC input source 202 and powers an AC load 204. The switched-mode power converter 104 includes various switches 108 that may control current flow in various ways. For example, the switches 108 may be configured to selectively power the load 204 from the input source 202, power the load 204 from the battery 102 (e.g., by converting a DC signal from the battery 102 into an AC signal), and/or charge the battery 102 using the input source 202 (e.g., by converting an AC signal from the input source 202 to a DC signal).

FIG. 2A further illustrates a DC/DC converter 206 interfaced with the battery 102. In this configuration, the DC/DC converter 206 may convert between a voltage provided by the battery 102 (e.g., a battery voltage) and different DC voltage. In some embodiments, the DC/DC converter 206 is a switched-mode converter and includes one or more internal switches (not shown), which may also optionally be controlled via control signals from the controller 106.

The control and intentional application of harmonic currents to the battery 102 is now described in greater detail, in accordance with one or more embodiments of the present disclosure. It is contemplated herein that operation of the various switches 108 in a switched-mode power converter 104 (e.g., the various switches 108 shown in FIG. 2A and/or within the DC/DC converter 206 (not shown)) may induce harmonic currents that may reach the battery 102.

These harmonic currents are generally considered to be undesirable in normal operation (e.g., operation of the battery 102 within its operational temperature range and load conditions). For this reason, the switched-mode power converter 104 may include a filter 208 that may partially or fully suppress the harmonic currents from reaching the battery 102.

The filter 208 may include any number or type of components suitable for at least partially suppressing harmonic signals from reaching the battery 102. For example, the filter 208 in FIG. 2A depicts an inductor 210 in series with the battery 102 operating as a low-pass filter and a capacitor 212 in parallel with the battery 102 (e.g., in parallel with terminals of the DC/DC converter 206) operating as a high-pass filter. However, this is merely illustrative and should not be interpreted as limiting the scope of the present disclosure. The filter 208 may include any components suitable for filtering of any frequencies.

It is contemplated herein that harmonic signals may be beneficial in some applications under controlled conditions. For example, harmonic signals may be used to heat the battery 102 in a way that does not require an external heater. As another example, harmonic signals may be used to condition the battery for regaining lost capacity, extending operating lifetime, or the like. For example, conditioning could aim to dissolve inert compounds, loosen adhered active material, or free trapped electrolytes. As an illustration, conditioning of lead-acid batteries may be directed at freeing sulfate crystals from plates. As another illustration, conditioning of lithium-ion batteries may target lithium metal plating.

Accordingly, in some embodiments, the switched-mode power converter 104 is operable in at least two operational modes: a harmonic-suppressed mode in which harmonic currents are either suppressed from reaching the battery 102 or eliminated altogether, or a harmonic-allowed mode in which harmonic currents are allowed to reach the battery 102.

The operational mode of the switched-mode power converter 104 may be controlled using at least some of the switches 108. For example, a first set of control signals to at least some of the switches 108 may provide the harmonic-suppressed mode and reduce (or eliminate) harmonic currents from reaching the battery 102, while a second set of control signals to at least some of the switches 108 may provide the harmonic-allowed mode and allow at least some harmonic currents to reach the battery 102.

The control signals may implement the harmonic-suppressed and harmonic-allowed modes using various techniques within the spirit and scope of the present disclosure.

In some embodiments, the control signals may switch between a harmonic-suppressed mode and a harmonic-allowed mode by directing one or more switches 108 to selectively enable or bypass the filter 208 in whole or part.

As an illustration, the switched-mode power converter 104 may include one or more switches 108 to selectively bypass the inductor 210 or the capacitor 212. For example, FIG. 2A depicts a switch 108 in parallel with the inductor 210 to selectively bypass this inductor as well as a switch 108 in series with the capacitor 212 to selectively bypass this capacitor 212. FIG. 2B illustrates a simplified schematic diagram of the switched-mode power converter 104 of FIG. 2A in which the filter 208 has been bypassed, in accordance with one or more embodiments of the present disclosure.

As another illustration, also not shown, the switched-mode power converter 104 may include one or more switches 108 to selectively connect filtering elements (e.g., inductors, capacitors, or the like) with different values to tune the performance of the filter 208. More broadly, the switched-mode power converter 104 may include one or more switches 108 in any configuration to selectively modify the performance of the filter 208. In this way, a harmonic-allowed mode may all harmonic currents generated by the switched-mode power converter 104 to reach the battery 102 or may allow only selected frequencies and/or amplitudes of harmonic currents generated by the switched-mode power converter 104 to reach the battery 102. Further, the power system 100 may provide multiple different harmonic-allowed modes, each providing harmonic currents with different characteristics (e.g., different frequency and/or amplitude characteristics) to reach the battery 102.

In some embodiments, the control signals may switch between a harmonic-suppressed mode and a harmonic-allowed mode by directing one or more switches 108 to implement power conversion (e.g., DC/DC power conversion, AC/DC power conversion, or the like) with different PWM profiles. For example, it may be the case that different PWM profiles (e.g., different combinations of frequency, duty cycle, or the like) applied to the various switches 108 may result in different harmonic currents (e.g., simply lowering PWM switching frequencies may increase harmonic currents). As an illustration, a first PWM profile may provide a harmonic-suppressed mode by either generating harmonic currents that are suppressed by the filter 208 or not generating meaningful harmonic currents at all, while a second PWM profile may provide a harmonic-allowed mode by generating harmonic currents that are passed by a filter 208 if present or simply passed to the battery 102 if a filter 208 is not present.

It is to be understood that FIGS. 2A-2B, along with the associated descriptions are provided solely for illustrative purposes and should not be interpreted as limiting the scope of the present disclosure. The switched-mode power converter 104 may have any design suitable for any type of power conversion (e.g., DC/DC power conversion, AC/DC power conversion, or the like) at any power levels that is compatible with selective application of harmonic currents to a battery 102 based on selective control of any number or locations of internal switches 108.

Various considerations associated with the application of controlled harmonic currents to a battery 102 are described in greater detail, in accordance with one or more embodiments of the present disclosure.

The power system 100 may include a switched-mode power converter 104 that is operable in any number of modes based on selective control of associated switches 108 (e.g., selectively controlling switches 108 to modify the performance of a filter 208 and/or selectively controlling switches 108 to provide power conversion with different PWM profiles). As a result, the power system 100 may support flexible and controlled application of harmonic currents to a battery 102 for a wide variety of applications or battery chemistries.

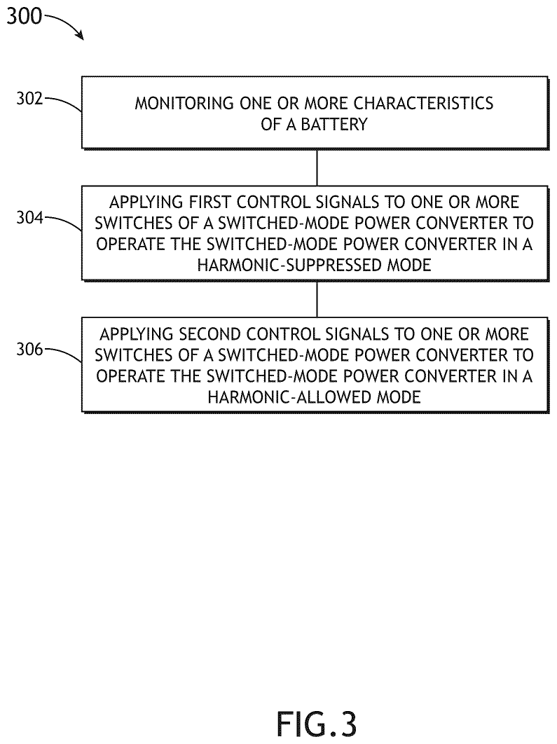

FIG. 3 illustrates a flow diagram illustrating steps performed in a method 300 for applying harmonic currents to a battery 102, in accordance with one or more embodiments of the present disclosure. The embodiments and enabling technologies described previously herein in the context of power system 100 should be interpreted to extend to the method 300. However, that the method 300 is not limited to the architecture of the power system 100. In this way, the descriptions of the various steps of the method 300 below referencing components of the power system 100 is merely illustrative and not limiting.

In some embodiments, the method 300 includes a step 302 of monitoring one or more characteristics of a battery 102. The step 302 may include monitoring any type of characteristics including, but not limited to, a temperature, a capacity, or a power output. Using the power system 100 depicted in FIG. 1 as an example, the power system 100 may include one or more sensors 114 to monitor one or more characteristics of the battery 102 (e.g., a temperature sensor, a current sensor, a voltage sensor, or the like). These sensors 114 may be implemented in any way including, but not limited to, as stand-alone components of the power system 100 as shown in FIG. 1, or integrated into another component (e.g., the battery 102).

In some embodiments, the method 300 includes a step 304 of applying first control signals to one or more switches 108 of a switched-mode power converter 104 to operate the switched-mode power converter 104 in a harmonic-suppressed mode. In this harmonic-suppressed mode, harmonics may not reach the battery 102 or may be suppressed within operational tolerances. For example, the battery 102 may be operated in the harmonic-suppressed mode when the battery 102 is in a first state based on data from the one or more sensors 114.

In some embodiments, the method 300 includes a step 306 of applying second control signals to one or more switches 108 of a switched-mode power converter 104 to operate the switched-mode power converter 104 in a harmonic-allowed mode. In this harmonic-allowed mode, harmonics are allowed to reach the battery 102.

In this way, step 304 and step 306 of the method 300 correspond to selectively preventing harmonic currents from reaching the battery 102 under some conditions (e.g., the first state) and allowing harmonic currents to reach the battery 102 under different conditions (e.g., the second state).

The first state and the second state may correspond to any properties or operational conditions of the battery 102. In some cases, the first state and the second state are measurable by one or more sensors 114.

In some embodiments, the method 300 provides selective heating of the battery 102 using harmonic currents. In this configuration, the first state and the second state correspond to operating temperature ranges of the battery 102. For example, the first state associated with the harmonic-suppressed mode may be applied when a temperature of the battery 102 (e.g., as measured by the sensors 114) is within a designated operational temperature range, whereas the second state corresponding to the harmonic-allowed mode may be applied when a temperature of the battery 102 is below the operational temperature range. In this way, the first state may correspond to normal operation of the battery without harmonic currents present and the second state may provide heating of the battery 102 when necessary. As an illustration, this harmonic-allowed mode may be used for pre-heating the battery 102 and/or maintaining a temperature of the battery 102 (e.g., if the temperature drops during normal operation).

In some embodiments, the method 300 provides conditioning of the battery 102 using harmonic currents. In this configuration, the first state may correspond to a designated nominal state such that various properties of the battery 102 such as, but not limited to, capacity or power performance, are within designated operational ranges. The second state may then correspond to a deteriorated state. Accordingly, harmonic currents may be intentionally provided to the battery 102 to condition the battery by dissolving inert compounds, loosening adhered active material, freeing trapped electrolytes, or providing any other conditioning step. In this way, the controlled use of harmonic currents may facilitate high performance and long battery lifetimes.

Referring now generally to FIGS. 1-3, it is contemplated herein that harmonic currents may be, but are not required to be, tailored to limit negative impacts to the battery 102. It is recognized that typical battery control circuits are designed to prevent harmonic currents from reaching a battery in order to avoid negative impacts such as, but not limited to decreased capacity, decreased power performance, or aging generally. However, it is contemplated herein that harmonic currents may be applied in ways that limit negative impacts to the battery 102 or in some cases even improve the performance of the battery 102.

In some embodiments, the harmonic currents applied to the battery 102 in a harmonic-allowed mode are unfiltered (e.g., have rich harmonic content). In this configuration, minimal attempts are made to tailor properties of the harmonic currents that reach the battery 102 in a harmonic-allowed mode. For example, the configuration in FIG. 2B may enable direct exposure of the battery 102 to harmonic currents generated by the switched-mode power converter 104. This approach may be well suited for, but not limited to, conditions in which either the properties of the harmonic currents do not negatively impact a particular type of battery 102 or the timescale in which harmonic currents are applied is sufficiently small that any negative impacts are within accepted tolerances.

In some embodiments, the harmonic currents applied to the battery 102 in a harmonic-allowed mode are tailored to limit negative impacts. For example, the performance of a filter (e.g., the filter 208 in FIGS. 2A-2B) may be modified by the switches 108 to control the presence and/or amplitudes of harmonic frequencies that reach the battery 102.

It may be the case that the impact of harmonic currents on a battery 102 may be a complex function of multiple factors such as, but not limited to, the battery chemistry, the frequency content of the harmonic currents, or the amplitude of any particular frequency components of the harmonic currents. As an illustration, the negative impacts of harmonic currents may diminish with increasing frequency for at least some battery chemistries. For instance, frequency-related impacts of harmonic currents on lithium-ion batteries are generally described in M. J. Brand, et al., “The Influence of Current Ripples on the Lifetime of Lithium-Ion Batteries,” in IEEE Transactions on Vehicular Technology, vol. 67, no. 11, pp. 10438-10445, Nov. 2018; which is incorporated herein by reference in its entirety. This reference suggests that harmonics with frequency content above approximately 30 Hz does not degrade battery life under the tested conditions.

Further, harmonic currents may generally have any amplitude relative to load currents (e.g., DC currents). For example, the harmonic currents have an amplitude up to ⅔ of the load currents. However, this is merely in illustration and should not be interpreted as limiting the scope of the present disclosure.

More generally, it is contemplated herein that various properties of harmonic currents applied to a battery 102 in a harmonic-allowed mode such as, but not limited to, frequency content or amplitudes of any particular frequency content may be tailored based on the specific battery chemistry to minimize, mitigate, control, or eliminate negative impacts to the battery 102. This tailoring may be achieved using any suitable technique. For example, properties of the harmonic currents may be tailored by tuning the properties of a filter 208 as described previously herein. As another example, properties of the harmonic currents may be tailored using PWM techniques.

Further, in some embodiments, it may be possible to improve battery performance using controlled harmonic currents. For example, as described above with respect to conditioning, tailored harmonic currents may be able to reverse aging effects and/or regain lost capacity under certain conditions and for certain battery chemistries. In this way, the properties of the harmonic currents allowed to reach the battery 102 in a harmonic-allowed mode may be tailored based on a particular battery chemistry.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A battery control circuit comprising:
a switched-mode power converter including one or more switches to control current to or from a battery; and
a controller to control operational states of the one or more switches, wherein the controller is configured to operate the switched-mode power converter in one of two or more operational modes, wherein the two or more operational modes comprise:
a harmonic-suppressed mode associated with first control signals to the one or more switches in which harmonic currents from the switched-mode power converter are at least one of suppressed from reaching the battery or eliminated; and
a harmonic-allowed mode associated with second control signals to the one or more switches in which the harmonic currents from the switched-mode power converter reach the battery.

2. The battery control circuit of claim 1, wherein the controller is configured to operate in the harmonic-allowed mode when a temperature of the battery is below an operational temperature range of the battery, wherein the controller is configured to operate in the harmonic-suppressed mode when the temperature is within the operational temperature range.

3. The battery control circuit of claim 1, wherein the harmonic currents reaching the battery in the harmonic-allowed mode are configured to condition the battery.

4. The battery control circuit of claim 3, wherein the harmonic currents reaching the battery in the harmonic-allowed mode are configured to condition the battery by at least one of dissolving inert compounds, loosening adhered active material, or freeing trapped electrolytes.

5. The battery control circuit of claim 3, wherein the battery is a lead-acid battery, wherein the harmonic currents reaching the battery in the harmonic-allowed mode are configured to condition the battery by freeing sulfate crystals from plates in the battery.

6. The battery control circuit of claim 3, wherein the battery is a lithium-ion battery, wherein the harmonic currents reaching the battery in the harmonic-allowed mode are configured to condition the battery by conditioning lithium metal plating in the battery.

7. The battery control circuit of claim 1, wherein the harmonic currents reaching the battery in the harmonic-allowed mode are configured to extend an operational lifetime of the battery.

8. The battery control circuit of claim 1, wherein the harmonic currents reaching the battery in the harmonic-allowed mode are configured to regain lost capacity of the battery.

9. The battery control circuit of claim 1, wherein the switched-mode power converter includes a filter, wherein operation of the filter is controlled by at least one of the one or more switches, wherein the filter is operational in the harmonic-suppressed mode to provide that the harmonic currents from the switched-mode power converter are at least one of suppressed from reaching the battery or eliminated, wherein the filter is bypassed in the harmonic-allowed mode to provide that the harmonic currents from the switched-mode power converter reach the battery.

10. The battery control circuit of claim 1, wherein the switched-mode power converter includes a filter, wherein operation of the filter is controlled by at least one of the one or more switches, wherein the filter is operational in the harmonic-suppressed mode to provide that the harmonic currents from the switched-mode power converter are at least one of suppressed from reaching the battery or eliminated, wherein the filter is tuned in the harmonic-allowed mode to provide that the harmonic currents from the switched-mode power converter that reach the battery have at least one of tailored frequencies or amplitudes.

11. The battery control circuit of claim 9, wherein the filter comprises at least one of an inductor in series with the battery or a capacitor in parallel with the battery.

12. The battery control circuit of claim 1, wherein the first control signals comprise first PWM signals (pulse width modulation signals), wherein the second control signals comprise second PWM signals.

13. The battery control circuit of claim 12, wherein the first PWM signals and the second PWM signals differ by at least one of frequency or duty cycle.

14. The battery control circuit of claim 1, wherein the switched-mode power converter comprises at least one of a DC/DC (direct current to direct current) power converter, an AC/DC (alternating current to direct current) power converter, or an AC/AC power converter.

15. A battery control circuit comprising:
a controller to control operational states of one or more switches of a switched-mode power converter for controlling current to or from a battery, wherein the controller is configured to operate the switched-mode power converter in one of two or more operational modes, wherein the two or more operational modes comprise:
a harmonic-suppressed mode associated with first control signals to the one or more switches in which harmonic currents from the switched-mode power converter are at least one of suppressed from reaching the battery or eliminated; and
a harmonic-allowed mode associated with second control signals to the one or more switches in which the harmonic currents from the switched-mode power converter reach the battery.

16. The battery control circuit of claim 15, wherein the controller is configured to operate in the harmonic-allowed mode when a temperature of the battery is below an operational temperature range of the battery, wherein the controller is configured to operate in the harmonic-suppressed mode when the temperature is within the operational temperature range.

17. The battery control circuit of claim 15, wherein the harmonic currents reaching the battery in the harmonic-allowed mode are configured to at least one of condition the battery, extend an operational lifetime of the battery, or regain lost capacity of the battery.

18. A battery control method comprising:
monitoring one or more characteristics of a battery;
applying first control signals to one or more switches of a switched-mode power converter to operate the switched-mode power converter in a harmonic-suppressed mode when the battery is in a first state, wherein harmonic currents from the switched-mode power converter are suppressed from reaching the battery; and
applying second control signals to the one or more switches to operate the switched-mode power converter in a harmonic-allowed mode when the battery is in a second state, wherein at least some of the harmonic currents from the switched-mode power converter are allowed to reach the battery.

19. The battery control method of claim 18, wherein the second state is applied when a temperature of the battery below an operational temperature range of the battery, wherein the first state is applied when the temperature is within the operational temperature range.

20. The battery control method of claim 18, wherein the harmonic currents reaching the battery in the harmonic-allowed mode are configured to at least one of condition the battery, extend an operational lifetime of the battery, or regain lost capacity of the battery.
